(19) United States
(12) Patent Application Publication
(10) Pub. No.: US 2007/0148333 A1
(43) Pub. Date: Jun. 28, 2007

(54) Manufacturing equipment of display device and manufacturing method of display device

(75) Inventor: Kazunori Morimoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/646,063

(22) Filed: Dec. 27, 2006

(30) Foreign Application Priority Data
Dec. 27, 2005 (JP) 2005-374987

(51) Int. Cl. B05D 5/06

(52) U.S. Cl. 427/66

(57) ABSTRACT

A manufacturing method of a display device, which has a display pixel having a light emitting element including a carrier transporting layer, includes a material fixing step of coating a solution containing a carrier transporting material on a pixel forming region for forming the display pixel and drying the solution to fix the carrier transporting material in a thin film form, and a carrier transporting layer forming step of coating a liquid material for remelting or redispersing the fixed carrier transporting material on the pixel forming region and forming the carrier transporting layer, which is made of the carrier transporting material.

### BACKGROUND OF THE INVENTION

1. Field of the Invention

The present invention relates to a manufacturing equipment of a display device and a manufacturing method of a display device, and particularly relates to a manufacturing equipment of a display device and a manufacturing method of a display device for manufacturing a display device having a display panel on which arrayed are a plurality of display pixels having a light emitting element which has a light emitting function layer (organic EL layer) formed therein with a liquid material comprising a light emitting function material coated.

2. Description of the Related Art

Recently, as next-generation display devices that follow liquid crystal display devices (LCD) widely used as monitors and displays of personal computers, video equipment, portable information devices, etc., displays (display devices) having a display panel of a light emitting element type, on which self light emitting elements such as organic electroluminescence elements (hereinafter abbreviated as “organic EL element”), light emitting diodes (LED), etc. are arrayed in two dimensions, have been vigorously researched and developed so that they can be practically used and become widespread.

Particularly, a light emitting element type display that is adapted to the active matrix drive system has a higher display response speed and no view angle dependency and can obtain a display image with a higher luminance, a higher contract, a higher preciseness, etc. as compared with a liquid crystal display device. And such a light emitting element type display is advantageous since it can be formed into a slimmer and lighter body because it requires no backlight unlike a liquid crystal display device.

Here, a basic structure of a known organic EL element will be briefly explained, as an example of a self light emitting element used in a light emitting element type display.

FIG. 7 is a schematic cross sectional diagram showing a basic structure of an organic EL element.

As shown in FIG. 7, the organic EL element roughly has a structure where an anode (positive pole) electrode 112, an organic EL layer (light emitting function layer) 113 made of an organic compound, etc. (organic material), and a cathode (negative pole) electrode 114 are sequentially stacked on one surface side (the upper side in the diagram) of an insulating substrate 111 made of a glass substrate or the like. The organic EL layer 113 has a stacked structure of, for example, a hole transporting layer (hole injection layer) 113a made of a hole transporting material (hole injection layer forming material) and an electron-transporting light emitting layer (light emitting layer) 113b made of an electron-transporting light emitting material.

The organic EL element having the above-described element structure emits light (excited light) hv based on energy that is produced by the recombination of holes and electrons that are injected into the hole transporting layer 113a or into the electron-transporting light emitting layer 113b when a positive voltage is applied to the anode electrode 112 and a negative voltage is applied to the cathode electrode 114 from a direct-current voltage source 115 as shown in FIG. 7. At this time, the light emitting intensity of the light hv is controlled according to the amount of the current that flows across the anode electrode 112 and the cathode electrode 114.

Here, by forming either one of the anode electrode 112 and the cathode electrode 114 by using an electrode material having light transmissivity, and forming the other of the two by using an electrode material having a light shielding characteristic and reflectivity, it is possible to realize an organic EL element having a bottom emission type light emitting structure which emits light hν through the insulating substrate 111 as shown in FIG. 7, or an organic EL element having a top emission type light emitting structure which emits light hν through the cathode electrode 114 on the upper surface, not through the insulating substrate 111.

Various low molecular organic or polymer materials are known as the hole transporting material or the electron-transporting light emitting material for making the organic EL layer 113 (the hole transporting layer 113a and the electron-transporting light emitting layer 113b) of the organic EL element described above.

Generally, a low molecular organic material imparts a relatively high light emitting efficiency to the organic EL layer, but requires vapor deposition to be applied in its manufacturing process. Therefore, in selectively forming a thin organic film made of the low molecular organic material only on the anode electrode of the pixel forming region, it is necessary to use a mask for preventing the low molecular organic material from being vapor-deposited on the regions other than the anode electrode. And since this cannot avoid the low molecular organic material being adhered even onto the surface of the mask, there is a problem that the material loss is large in the manufacturing process and the manufacturing process is inefficient.

On the other hand, a polymer material gives a lower light emitting efficiency to the organic EL layer than given by a low molecular organic material, but it can allow the use of an ink jetting method (liquid drop jetting method), a nozzle printing method (liquid current jetting method) or the like as a wet film forming method. Therefore, only the pixel forming region (the region on the anode electrode) or a specific region including the pixel forming region can be selectively coated with the solution of the organic material, providing an advantage in the manufacturing process that a thin film of the organic EL layer (the hole transporting layer and the electron-transporting light emitting layer) can be formed efficiently and finely.

In the manufacturing process of an organic EL element having an organic EL layer made of such a polymer material, the organic EL layer 113 is formed roughly through the step of forming an anode electrode (positive electrode) on each region (pixel forming region) on which a display pixel is to be formed on an insulating substrate (panel substrate) made of a glass substrate or the like, forming a partitioning wall (bank) made of an insulating resin material or the like on the boundary between adjoining display pixels, and then, with the use of an ink jetting device or a nozzle printing device, coating a liquid material, which is made of a polymer hole-transporting material dispersed or dissolved in a solvent, on the region surrounded by the partitioning wall and heating and drying the coated region, thereby to form the hole transporting layer 113a shown in FIG. 7, and sequentially through the step of coating a liquid material made of a polymer electron-transporting light emitting material dispersed or dissolved in a solvent with subsequent heating and drying to form the electron-transporting light emitting layer 113b shown in FIG. 7.

That is, according to the manufacturing method using a wet film forming method such as the ink jetting method, the nozzle printing method, etc., the above-described partitioning walls continuously formed to project from the insulating substrate can define each pixel forming region and can prevent the phenomenon of the light emitting colors mixing (color mixing), etc. between the display pixels, due to liquid materials of different colors mixing into adjoining pixel forming regions when the liquid materials made of the polymer material are coated.

The structure of an organic EL element (display panel) with such a partitioning wall and a manufacturing method using the ink jetting manner or the nozzle printing manner for forming an organic EL layer (a hole transporting layer and an electron-transporting light emitting layer) are specifically explained in, for example, Unexamined Japanese Patent Application KOKAI Publication No. 2001-76881. In addition to the above-described ink jetting method and the nozzle printing method, methods utilizing various other printing techniques such as letterpress printing, screen printing, offset printing, gravure printing, etc. are proposed for the manufacturing process of an organic EL element having an organic EL layer made of a polymer material.

### SUMMARY OF THE INVENTION

However, according to the manufacturing method of an organic EL layer (a hole transporting layer and an electron-transporting light emitting layer) using a wet film forming method such as the ink jetting method or the nozzle printing method described above, etc., the liquid material tends to aggregate at the circumferential portion of the anode electrode 112 and partitioning wall 121 and the ends of the liquid surface of the coating liquid LQD are pressed up along the side surfaces of the partitioning wall 121 as shown in FIG. 8 to make the coating thickness large at the circumferential portion, due to the characteristic (water repellency) of the surface of the partitioning wall formed to protrude at the boundary between the display pixels (pixel forming regions), the surface tension and cohesion attributed to the solvent component in the liquid material (coating liquid) made of an organic material, and a drying manner after the liquid material is coated, etc., whereas the liquid material is coated thinly at about the center portion of the anode electrode 112. Therefore, there is a problem that the overall thickness of the organic EL layer formed in the pixel forming region becomes uneven. Note that FIG. 8 is a schematic diagram for explaining the problem of the manufacturing process of the organic EL element according to prior art.

Such unevenness of the film thickness of the organic EL layer formed in the pixel forming region brings about problems that the light emission start voltage in the light emitting operation and the wavelength (i.e., the chromaticity when the image is displayed) of the light hν emitted from the organic EL layer differ from the design values to make it impossible to obtain a desired display quality, and that a large light emission drive current flows intensively in a region of the organic EL layer where the film thickness is thin, to cause a large decrease of the ratio (the so-called aperture ratio) of the light emitting region occupied in the display panel (pixel forming region) and a large deterioration of the organic EL layer (organic EL element), thereby to reduce the reliability and longevity of the display panel.

Hence, in consideration of the above-described problems, an object of the present invention is to provide a manufacturing equipment of a display device and a manufacturing method of a display device for manufacturing a display device having a display panel on which a light emitting function layer (organic EL layer), whose film thickness is relatively uniform over generally the entire region of a pixel forming region, is formed.

A manufacturing method of a display device according to a first aspect of the present invention is a method for manufacturing a display device which has a display pixel having a light emitting element including a carrier transporting layer, and comprises:

a material fixing step of coating a solution containing a carrier transporting material on a pixel forming region for forming the display pixel, and drying the solution to fix the carrier transporting material in a thin film form; and

a carrier transporting layer forming step of coating a liquid material for remelting or redispersing the fixed carrier transporting material on the pixel forming region, and forming the carrier transporting layer, which is made of the carrier transporting material.

The liquid material for remelting or redispersing the carrier transporting material used at the carrier transporting layer forming step may contain a same material as a solvent in the solution containing the carrier transporting material used at the material fixing step.

The pixel forming region may be defined by partitioning walls.

A plurality of pixel forming regions for forming display pixels having light emitting elements for a same light emitting color as each other may be formed in a region surrounded by the partitioning walls.

In a process of coating the solution containing the carrier transporting material at the material fixing step and in a process of coating the liquid material for remelting or redispersing the carrier transporting material at the carrier transporting layer forming step, the solution or the liquid material may be continually coated onto a plurality of pixel forming regions, according to a nozzle printing method.

The carrier transporting material may comprise a polymer material, and the light emitting element may be an organic electroluminescence element.

The carrier transporting material may contain polyethylenedioxithiophene.

The carrier transporting material may contain a conjugated double bond polymer.

The solution containing the carrier transporting material may contain at least any of water, ethanol, and ethylene glycol.

The liquid material for melting or redispersing may contain at least any of water, ethanol, and ethylene glycol.

A manufacturing method of a display device according to a second aspect of the present invention is a method for manufacturing a display device which has a display pixel having a light emitting element including a carrier transporting layer, and comprises:

a material fixing step of coating a solution containing a carrier transporting material on a pixel forming region for forming the display pixel defined by partitioning walls, and drying the solution to fix the carrier transporting material in a thin film form; and

a carrier transporting layer forming step of coating a same material as a solvent contained in the solution containing the carrier transporting material, as a liquid material for remelting or redispersing the fixed carrier transporting material, and forming the carrier transporting layer, which is made of the carrier transporting material.

A manufacturing equipment of a display device according to a third aspect of the present invention coats a carrier transporting material, which has been fixed in a thin film form by a solution containing the carrier transporting material being coated on a pixel forming region for forming a display pixel, with a liquid material for remelting or redispersing the carrier transporting material.

### BRIEF DESCRIPTION OF THE DRAWINGS

These objects and other objects and advantages of the present invention will become more apparent upon reading of the following detailed description and the accompanying drawings in which:

FIG. 1A is a schematic plan view of a principal part showing an example of the pixel array on a display panel to be used in a display device according to the present invention, and FIG. 1B is a cross sectional view as taken along an A-A line shown in FIG. 1A;

FIGS. 2A and 2B are schematic structure diagrams showing an example of a printer head to be used in a manufacturing equipment of a display device according to an embodiment of the present invention;

FIGS. 3A to 3E are cross sectional diagrams of manufacturing steps (part 1) showing an example of a manufacturing method of a display device (display panel) according to the embodiment of the present invention;

FIGS. 4A to 4D are cross sectional diagrams of manufacturing steps following FIGS. 3A to 3E (part 2);

FIGS. 5A to 5D are conceptual diagrams showing states of the surface of a film at the steps of forming an organic EL layer (hole transporting layer) according to the embodiment of the present invention;

FIG. 6A is a graph showing the state of the surface (the height of the surface) of the hole transporting layer, for proving the effects achieved at the steps of forming the organic EL layer (hole transporting layer) according to the embodiment of the present invention, and FIG. 6B is a graph particularly showing the portion Rpr shown in FIG. 6A in enlargement;

FIG. 7 is a schematic cross sectional diagram showing a basic structure of an organic EL layer; and

FIG. 8 is a schematic diagram for explaining problems in a manufacturing process of an organic EL element according to the prior art.

### DETAILED DESCRIPTION OF THE PREFERRED EMBODIMENT

A manufacturing equipment and manufacturing method of a display device according to the present invention will be specifically explained below, by showing an embodiment. In the embodiment to be shown below, a case that an organic EL element having an organic EL layer made of the above-described polymer material is used as a light emitting element for forming a display pixel will be explained.

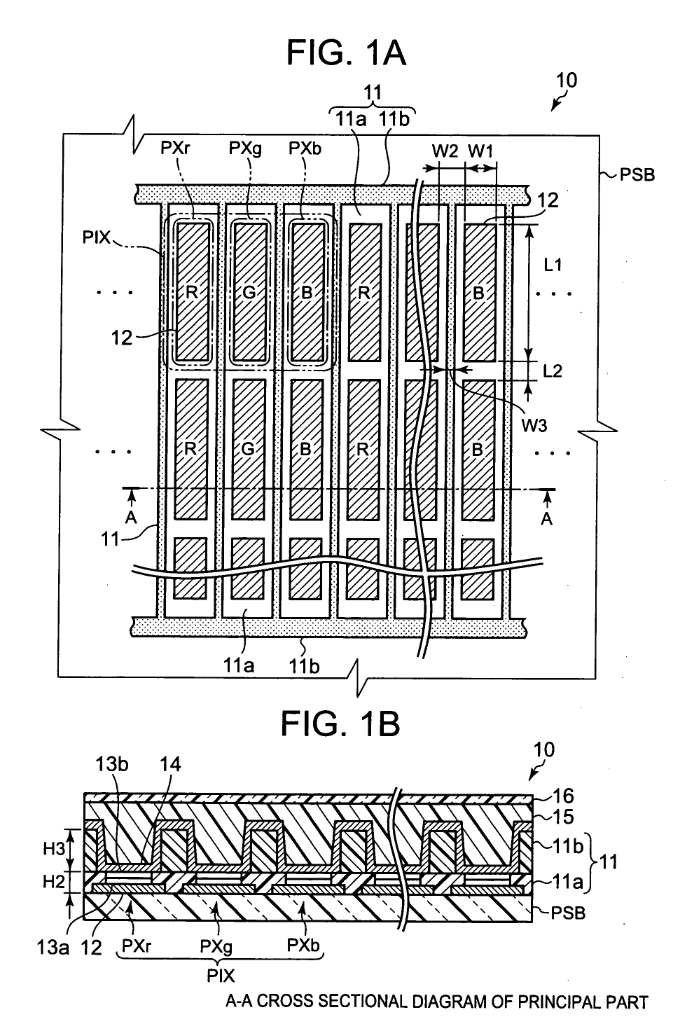

First, a display panel and display pixels to be used in the display device according to the present invention will be explained. FIGS. 1A and 1B are schematic views of a principal part showing an example of the pixel array on the display panel used in the display device according to the present invention. FIG. 1A is a plan view of the display panel and FIG. 1B is a cross sectional view of the display panel shown in FIG. 1A as taken along an A-A line. For facilitating understanding, the plan view of FIG. 1A shows only pixel electrodes formed in respective display pixels (color pixels) and partitioning walls (banks) for defining the regions in which the display pixels are formed, when the display panel is seen from its observer side. And the pixel electrodes and the partitioning walls are illustrated expediently with hatchings to make the arrangement of the pixel electrodes and partitioning walls clear.

As shown in FIG. 1A, the display device (display panel) according to the present invention has color pixels PXr, PXg, and PXb having three colors of red (R), green (G), and blue (B) arrayed on one surface of a panel substrate PSB made of an insulating substrate such as a glass substrate or the like, such that the color pixels are sequentially and repeatedly arrayed in the horizontal direction of the diagram over a plural number (a multiple of 3) of columns, and are arrayed in the vertical direction of the diagram over a plural number of rows on the basis of a single color in each column. Here, adjoining color pixels PXr, PXg, and PXb having the three colors form a group and constitute one display pixel PIX.

As shown in FIGS. 1A and 1B, regions (corresponding to pixel forming regions Apx to be described later) including regions for forming a plurality of color pixels PXr, color pixels PXg, or color pixels PXb, among the plurality of display pixels PIX (color pixels PXr, PXg, and PXb) two-dimensionally arrayed on one surface of the panel substrate PSB, that are arrayed in the vertical direction of FIG. 1A and thus unified in color, are defined on the display panel 10 by partitioning walls (banks) 11 provided on the one surface of the panel substrate PSB so as to project therefrom to form a planar pattern having a fence-like or a lattice-like shape. The regions for forming the plurality of color pixels PXr, color pixels PXg, or color pixels PXb, which are included in the these defined regions are each provided with a pixel electrode 12.

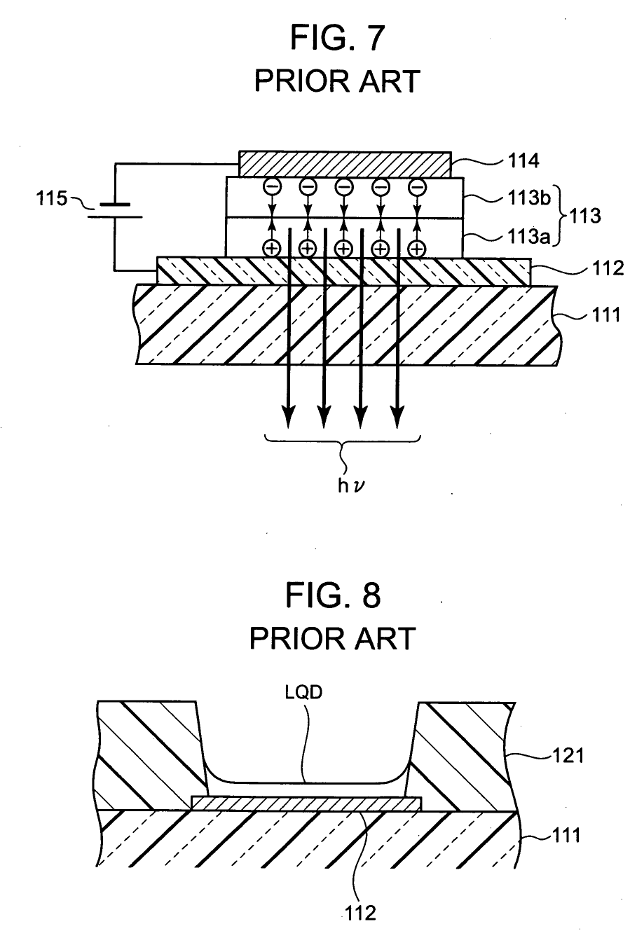

Likewise the basic structure (see FIG. 7) of the organic EL element shown in the related art, each display pixel PIX (color pixel PXr, PXg, and PXb) has an element structure as shown in FIG. 1B, in which a pixel electrode (for example, the anode electrode) 12, an organic EL layer (a hole transporting layer 13a and an electron-transporting light emitting layer 13b; a light emitting function layer), and an opposing electrode (for example, a cathode electrode) 14 are sequentially stacked on the pixel forming region defined by the partitioning walls 11, which are formed on the one surface side of the panel substrate PSB to project therefrom. The opposing electrode 14 is formed as a single electrode layer, which is common to the display pixels PIX (color pixels PXr, PXg, and PXb) arrayed two-dimensionally on the panel substrate PSB. A sealing substrate 16 is joined, via, for example, a protective insulating film or a sealing resin layer 15, to the panel substrate PSB, on which the display pixels PIX (color pixels PXr, PXg, and PXb) having the above-described element structure are arrayed.

<Manufacturing Equipment of Display Device>

A manufacturing equipment of a display device according to the present embodiment will be described below.

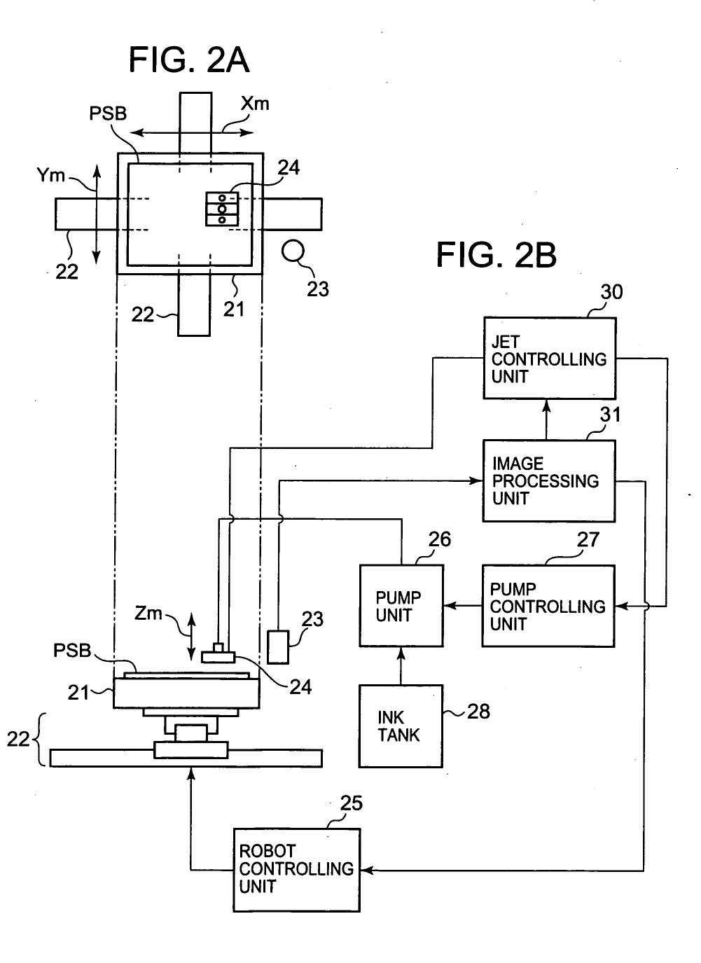

FIGS. 2A and 2B are schematic structure diagrams showing an example of a printer head to be used in the manufacturing equipment of the display device according to the present embodiment. FIG. 2A is a plan view (top view) of the printer head. FIG. 2B is a diagram showing an example of the structure of the manufacturing equipment, including a side elevation of the printer head. The manufacturing equipment of the display device comprises an ink jetting mechanism section for jetting an aqueous ink (a hole transporting material containing liquid) and an aqueous ink or an organic solvent ink (light emitting material containing liquid), and a substrate moving mechanism section for moving in the directions of a two-dimensional coordinate system relatively to the printer head (described later in detail) provided in the ink jetting mechanism section, while a panel substrate (insulating substrate) to be coated with the aqueous ink or the organic solvent ink is mounted on the substrate moving mechanism section. The hole transporting material containing liquid is an aqueous ink having a strong acidity, which is obtained by dissolving or diffusing, as the hole transporting material, for example, polyethylenedioxithiophene PEDOT, which is a conductive polymer, and polystyrenesulfonate PSS, which is a dopant (hereinafter, these are abbreviated as “PEDOT/PSS”), in an aqueous solvent such as water, ethanol, ethylene glycol, etc. The light emitting material containing liquid is an aqueous ink or an organic solvent ink, which is obtained by dissolving or diffusing, as the electron-transporting light emitting material, for example, florene polymer or phenylenevinylene polymer in an aromatic organic solvent such as tetraphosphor, tetramethylbenzene, mesitylene, xylene, toluene, etc. or in water.

(Ink Jetting Mechanism Section)

As shown in FIG. 2A, the ink jetting mechanism section comprises at least a printer head 24 for jetting the above-described aqueous ink or organic solvent ink and radiating infrared light for heating and drying the coated aqueous ink or organic solvent ink, a pump unit 26 for supplying the aqueous ink or the organic solvent ink to the printer head 24, a pump controlling unit 27 for controlling supply conditions such as the amount or timing of supplying the aqueous ink or the organic solvent ink to the printer head 24 from the pump unit 26, an ink tank 28 for storing the aqueous ink or the organic solvent ink and a solvent. FIG. 2A is a structure diagram of the printer head 24 and a substrate stage 21 as seen from the top. The substrate stage 21 can move to an arbitrary position on an X-Y plane (Xm direction and Ym direction), by means of an X-Y dual axial robot 22. FIG. 2B is a structure diagram of the control system when the printer head 24 and the substrate stage 21 are seen from their side. The printer head 24 can move up or down to a predetermined position in a Zm direction (upward and downward direction).

(Printer Head)

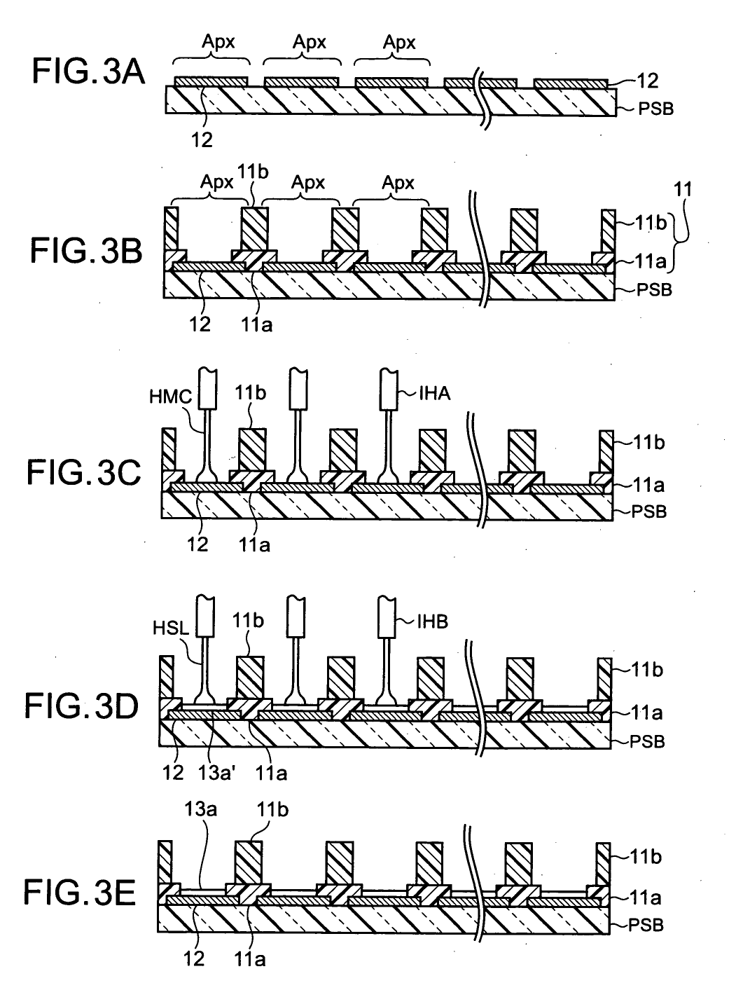

As shown in, for example, FIG. 2B, the printer head 24 is set above the substrate mounting surface of the substrate stage 21, at a predetermined position fixed with respect to the moving directions (the X-Y two axial directions; indicated by arrows Xm and Ym in FIG. 2A) of the substrate stage 21. Further, as shown in FIG. 3C, the printer head 24 comprises an ink nozzle IHA, which jets and coats the aqueous ink or the organic solvent ink on the panel substrate PSB.

The printer head 24 comprises not only the ink nozzle IHA, but also ink nozzles IHB, IEA, and IEB.

Specifically, the ink nozzle IHA has a hollow housing structure, and comprises an ink storage unit for storing an organic solution HMC, which is an aqueous ink or an organic solvent ink dispersed or dissolved in a solvent HSL, an inlet port formed on the top surface of the ink storage unit, from which the organic solution HMC supplied from the pump unit 26 described later is supplied into the ink storage unit, a plurality of jetting ports formed in the bottom surface of the ink storage unit and provided in line in a direction in which the ink nozzle IHA is elongate, for jetting the organic solution HMC supplied into the ink storage unit, and a control line connected to ajet controlling unit 30, which is for outputting a control signal for controlling the ink nozzle IHA to jet ink of an amount that is based on image information data input to an image processing unit 31.

The ink nozzle IHB has a similar structure to that of the ink nozzle IHA, but comprises an ink storage unit for storing, instead of the organic solution HMC, a solvent HSL, which is of the same kind as the solvent HSL used in the organic solution HMC, and a plurality ofjetting ports forjetting the solvent HSL. The ink nozzle IHB stores the solvent HSL supplied from the ink tank 28 through the pump unit 26 in the ink storage unit.

The ink nozzle IEA has a similar structure to that of the ink nozzle IHA, but comprises an ink storage unit for storing a later-described organic solution EMC instead of the organic solution HMC, and a plurality of jetting ports for jetting the organic solution EMC. The ink nozzle IEA stores the organic solution EMC supplied from the ink tank 28 through the pump unit 26 in the ink storage unit. The printer head 24 (ink nozzle IEA) may comprise a single ink storage unit for storing the organic solution EMC of a single color, or may comprise a plurality of ink storage units for storing organic solutions EMC corresponding to red (R), green (G), and blue (B) respectively, a plurality of inlet ports for separately inletting the organic solutions EMC of R, G, and B into the corresponding ink storage units, and a plurality of jetting ports for separately jetting the organic solutions EMC of R, G, and B, which are supplied into the corresponding ink storage units.

The ink nozzle IEB has a similar structure to that of the ink nozzle IHA, but comprises an ink storage unit for storing, instead of the organic solution HMC, a solvent ESL which is of the same kind as a solvent ESL used in the organic solution EMC, and a plurality of jetting ports for jetting the solvent ESL. The ink nozzle IEB stores the solvent ESL supplied from the ink tank 28 through the pump unit 26 in the ink storage unit.

Here, the ink nozzle IHA will be explained as the representative. Since the inlet port formed on the ink nozzle IHA is connected to an outlet port of the later-described pump unit 26 by a tube (or a duct), and lets in the organic solution HMC from the ink tank 28 with the pump unit 26 appropriately driven by the pump controlling unit 27 based on an amount of ink ejection from the ink nozzle IHA that is computed by the jet controlling unit 30, the ink storage unit is full of ink all time. The ink nozzle IHA (printer head 24) is a piezoelectric element such as a piezo element, etc., or a heat-generating resistor element, and jets the organic solution HMC of a predetermined amount from the plurality of jetting ports simultaneously, onto the substrate stage 21, in accordance with a control signal input from the control line CBL. The jetted organic solution HMC is coated on a predetermined region (pixel forming region) of the panel substrate PSB, by the substrate stage 21 being moved relatively to the printer head 24 in the X-Y two axial directions (two-dimensional coordinate directions), as will be described later. This mechanism is common to the ink nozzles IHB, IEA, and IEB, not only the IHA, except the material stored in them respectively.

The printer head 24 may be attached to an arm member or the like (unillustrated) that can be moved in a direction (indicated by an arrow Zm) perpendicular to the moving directions (X-Y directions; see FIG. 2A) of the substrate stage 21 as shown in FIG. 2B, so that the clearance between the jetting ports of the ink nozzle IHA and the panel substrate PSB (or the substrate stage 21) (the distance from the panel substrate PSB in the vertical direction) can be adjusted.

(Pump Unit)

The pump unit 26 absorbs the organic solution HMC that is stored in the ink tank 28 and sends the ink to the printer head 24 (ink nozzle IHA) based on a drive signal output from the pump controlling unit 27, and the ink storage unit is thus filled with the organic solution HMC.

(Jet Controlling Unit)

The jet controlling unit 30 outputs a control signal for controlling the amount of ejection by the printer head 24 to the control line based on an analysis result obtained by the image processing unit 31 analyzing image information data, and also outputs ejection amount data to the pump controlling unit 27.

(Substrate Moving Mechanism Section)

As shown in FIGS. 2A and 2B, the substrate moving mechanism section comprises, for example, the substrate stage 21 on which the panel substrate PSB is mounted and fixed, the X-Y dual axial robot 22 for moving the substrate stage 21 in two axial directions of X direction and Y direction that are orthogonal to each other, an alignment (positioning) camera 23 for detecting and adjusting the mounting position (matching status of an alignment mark) of the panel substrate PSB with respect to the substrate stage 21 (or to the printer head 24 fixed at a predetermined reference position with respect to the substrate stage 21), the image processing unit 31 for analyzing an image picked up by the alignment camera 23, and a robot controlling unit 25 for controlling the amount of movement of the X-Y dual axial robot 22 (or the position to which the X-Y dual axial robot 22 is moved) based on an analysis result so that the substrate stage 21 may be set to a predetermined positional relation with respect to the printer head 24.

The substrate stage 21 has, though not illustrated, a vacuum attracting mechanism or a mechanical support system for fixing the panel substrate PSB mounted thereon at a predetermined position. The X-Y dual axial robot 22 moves the substrate stage 21 (i.e., the panel substrate PSB mounted and fixed) attached on the X-Y dual axial robot 22 in the two-dimensional coordinate directions and sets the substrate stage 21 to a predetermined positional relation with respect to the printer head 24, by moving in the X axial direction and in the Y axial direction independently.

Further, the substrate stage 21 is structured to be also minutely adjustable in the rotational direction in addition to the above-described X-Y two axial directions, for the purpose of the alignment (positioning) of the initial jetting position of the printer head 24 with respect to the panel substrate PSB. Likewise the printer head 24, the alignment camera 23 for detecting the alignment mark, which is formed on the panel substrate PSB in advance, may also be fixed at a predetermined position with respect to the moving directions of the substrate stage 21.

<Manufacturing Method of Display Device>

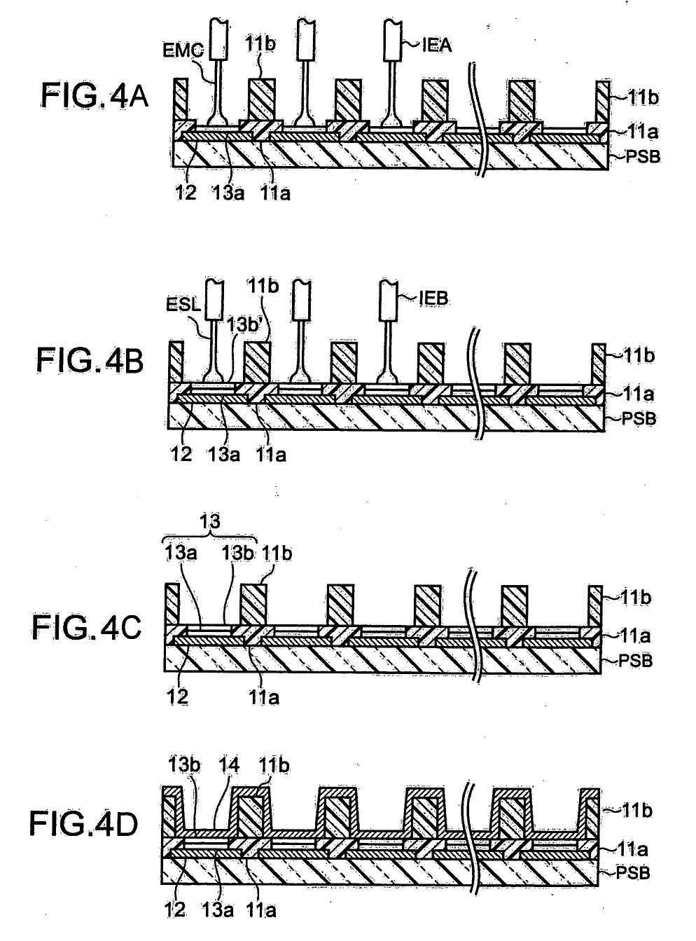

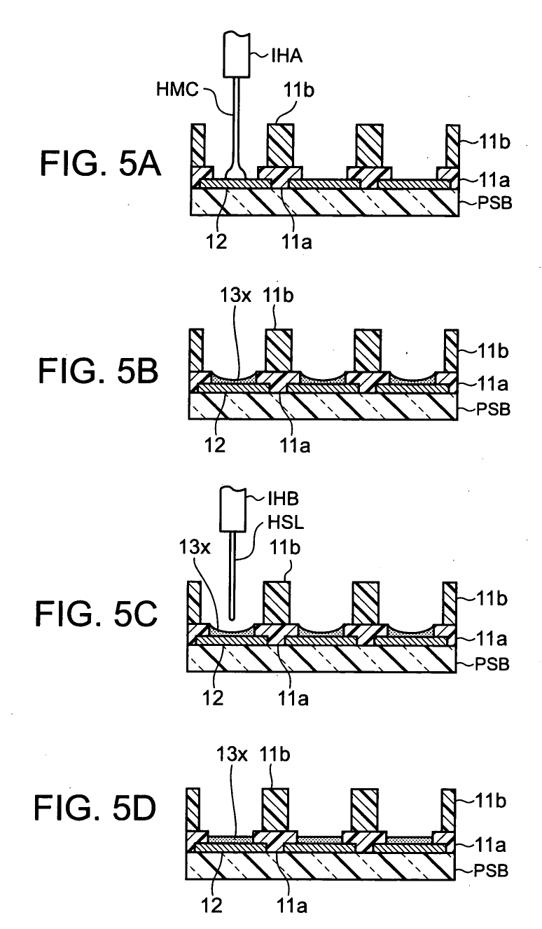

FIGS. 3A to 3E and FIGS. 4A to 4D are cross sectional diagrams of manufacturing steps, showing an example of the manufacturing method of the display device (display panel) according to the present embodiment. Here, a case will be explained that a color display panel having display pixels PIX each including a group of color pixels PXr, PXg, and PXb having three colors of red (R), green (G), and blue (B) shown in FIGS. 1A and 1B is manufactured according to the nozzle printing method. FIGS. 5A to 5D are schematic cross sectional diagrams of a principal part, for explaining the steps of forming the organic EL layer of the display device (display panel) according to the present embodiment.

According to the manufacturing method of the display device according to the present embodiment, first, a pixel electrode (for example, an anode electrode) 12, which comprises a metal layer having light transmissivity and a transparent electrode layer made of indium-tin-oxide (ITO), indium zinc oxide, indium oxide (In₂O₃), tin oxide (SnO₂), zinc oxide (ZnO), cadmium-tin-oxide (CTO), or the like, is formed, as shown in FIG. 3A, in each pixel forming region Apx arranged in the form of a matrix on one surface side (the upper side of the diagram) of the panel substrate PSB, which is made of an insulating substrate such as a glass substrate. Then, as shown in FIG. 3B, an interlayer insulating film 11a made of an insulating material such as a silicon nitride film or the like is formed on the boundary between adjoining pixel forming regions Apx (on the region between the pixel electrodes 12), and partitioning walls (banks) 11b made of an insulating resin material such as polyimide (PI) or the like are formed on the interlayer insulating films 11a (region defining step). As apparent from the above, the interlayer insulating films 11a are formed such that the center portion of each pixel electrode 12 is exposed and the circumferential portions of each pixel electrode 12, i.e., the four aspects of each pixel electrode 12 are covered with the interlayer insulating films 11a. The interlayer insulating films 11a may be formed to cover only two opposing sides, among the four circumferential portions of each pixel electrode 12, as long as the center portion of the pixel electrode 12 is exposed.

The pixel electrode 12 is exposed in each pixel forming region Apx surrounded by the interlayer insulating films 11a and the partitioning walls 11b. According to the present embodiment, the structure in which only the pixel electrodes 12 are formed on the panel substrate PSB to be defined into pixel forming regions Apx is illustrated. However, a drive control element (for example, a thin film transistor) for controlling a light emission drive current to be supplied to a later-described organic EL layer 13 (a hole transporting layer 13a and an electron-transporting light emitting layer 13b) may be connected to each pixel electrode 12.

Next, after the surface of the panel substrate PSB is cleaned with pure water or alcohol, with the use of a known nozzle printing device, an organic solution HMC, which is obtained by adding a hole transporting material (a carrier transporting material; for example, polyethylenedioxithiophene (PEDOT)/polystyrenesulfonate (PSS)), that contains an organic compound, in a solvent medium (for example, water, ethanol, ethylene glycol, etc., preferably, water of 100 to 80 wt % and ethanol of 0 to 20 wt %), is jetted, in a liquid current form, from each ink nozzle IHA, which is positioned to correspond to each pixel forming region Apx, and continually coated on the pixel electrode 12 of each pixel forming region Apx, as shown in FIG. 3C. After this, the panel substrate PSB is heated to a predetermined temperature to vaporize the solvent (the solvent medium described above) in the organic solution HMC and fix a hole transporting material film 13a′ having a thin film form on the pixel electrode 12 of each pixel forming region Apx (material fixing step). Microscopically, the hole transporting material film 13a′ is deposited more thickly at the circumferential portions along the interlayer insulating films 11a and partitioning walls 11b, than at the center portion, likewise in FIG. 8. The organic solution may not only be one in which the hole transporting material is completely dissolved, but may be one in which the hole transporting material is more or less diffused. That is, the solvent here is one in which the carrier transporting material as the solute is at least partially dissolved or diffused, and includes such one in which the solute is not completely dissolved.

Next, as shown in FIG. 3D, the solvent (for example, water, ethanol, ethylene glycol, etc., preferably, water of 100 to 80 wt % and ethanol of 0 to 20 wt %) HSL, which is used in the organic solution HMC, is jetted, in a liquid current form, from each ink nozzle IHB of the nozzle printing device, which is positioned to correspond to each pixel forming region Apx, and continually coated on the hole transporting material film 13a′ fixed on the surface of the pixel electrode 12 of each pixel forming region Apx, likewise in the above described step of coating the organic solution HMC. At this time, the solvent HSL remelts at least part of the hole transporting material film 13a′ once fixed. After this, the panel substrate PSB is heated to a predetermined temperature to vaporize the solvent HSL to dry the hole transporting material and form a hole transporting layer (carrier transporting layer) 13a on the pixel electrode 12 of each pixel forming region Apx (carrier transporting layer forming step). At this time, the hole transporting layer 13a results in having a flatter surface than the hole transporting material film 13a′.

At the above-described step of forming the hole transporting layer 13a, after the cleaning by pure water or alcohol is finished, in advance of the step (FIG. 3C) of coating the organic solution HMC on the pixel electrode 12 of each pixel forming region Apx, at least a part (for example, PEDOT) of the hole transporting material may be thinly coated in the pixel forming region Apx (on the surface of the pixel electrode 12) to lyophilicize the surface of the pixel electrode 12.

Further, in advance of the step (FIG. 3C) of coating the organic solution HMC in each pixel forming region Apx, ultraviolet rays may be radiated onto the surface of the panel substrate PSB in, for example, an oxygen gas atmosphere to generate active oxygen radicals to lyophilicize the surface of the pixel electrodes 12, and thereafter ultraviolet rays may be radiated onto the panel substrate PSB in, for example, a fluoride gas atmosphere such as carbon fluoride (CF₄) to make fluorine combine only with the surface of the interlayer insulating films 11a and partitioning walls 11b to selectively impart liquid repellency to them (CF₄ plasma cleaning process), thereby to form a hydrophilic and hydrophobic pattern where the lyophilicity of the surface of the pixel electrodes 12 is maintained.

With such a treatment, at the step of coating the organic solution HMC containing the hole transporting material and at a later-described step of coating the organic solution EMC containing an electron-transporting light emitting material, eve if the liquid drops of the organic solution HMC or EMC land on the interlayer insulating films 11a and the partitioning walls 11b, the liquid drops are repelled because of the liquid repellency on their surface, and coated intensively in the pixel forming regions Apx (on the pixel electrodes 12) having lyophilicity.

Next, as shown in FIG. 4A, with the use of the nozzle printing device, organic solutions EMC, which are obtained by adding organic polymer electron-transporting light emitting materials (carrier transporting materials; for example, conjugated double bond polymer such as polyphenylenevinylene mentioned above, polyflorene, etc.) corresponding to the light emitting colors of red (R), green (G), and blue (B) respectively, in a water-soluble or oleophilic solvent medium (including at least any of, for example, water, ethanol, ethylene glycol, toluene, xylene, etc.), are jetted, in a liquid current form, simultaneously from ink nozzles IEA, which are positioned to respectively correspond to the regions (pixel forming regions Apx) for forming the color pixels PXr, PXg, and PXb for red (R), green (G), and blue (B), which are arrayed adjacently on the panel substrate PSB, so that the organic solutions EMC are continually coated on the hole transporting layer 13a, which are formed on the pixel electrode 12 of each pixel forming region Apx in the above-described step. After this, the panel substrate PSB is heated to a predetermined temperature to vaporize the solvent (the above-described solvent medium) in the organic solutions EMC and fix an electron-transporting light emitting material film 13b′ having a thin film form on the hole transporting layer 13a of each pixel forming region Apx (material fixing step).

Then, as shown in FIG. 4B, the solvent (for example, water, ethanol, ethylene glycol, toluene, xylene, etc.) ESL in the above-described organic solutions EMC is jetted, in a liquid current form, from each ink nozzle IEB of the nozzle printing device, which is positioned to correspond to each pixel forming region Apx, and continually coated on the electron-transporting light emitting material 13b′ fixed on the surface of the hole transporting layer 13a of each pixel forming region Apx, likewise in the above-described step of coating the organic solutions EMC. At this time, the solvent ESL remelts at least part of the electron-transporting light emitting material film 13b′ once fixed. After this, the panel substrate PSB is heated to a predetermined temperature to vaporize the solvent ESL to dry the electron-transporting light emitting material and form an electron-transporting light emitting layer (carrier transporting layer) 13b on the hole transporting layer 13a of each pixel forming region Apx, as shown in FIG. 4C (carrier transporting layer forming step). At this time, the electron-transporting light emitting layer 13b results in having a flatter surface than the electron-transporting light emitting material film 13b′.

Regarding the step of coating the organic solutions EMC shown in FIG. 4A, a case has been explained that the organic solutions EMC, which contain electron-transporting light emitting materials corresponding to the light emitting colors of red (R), green (G), and blue (B) respectively, are simultaneously jetted from the corresponding ink nozzles IEA and coated on the regions (pixel forming regions Apx) for forming the color pixels PXr, PXg, and PXb for red (R), green (G), and blue (B), which are arrayed adjacently on the panel substrate PSB. However, the present invention is not limited to this case. The regions for forming a plurality of color pixels for the sane color (for example, the regions for forming color pixels PXr for red (R)), among the color pixels PXr, PXg, and PXb constituting the display pixels PIX, may be simultaneously coated with the organic solution EMC, which contains an electron-transporting light emitting material corresponding to that light emitting color.

Further, regarding both the step of forming the hole transporting layer 13a and the step of forming the electron-transporting light emitting layer 13b, a case has been explained that the organic solution HMC or EMC is coated and dried, and then the solvent HSL or ESL in that solution is coated. However, the present invention is not limited to this case, but the above-described manufacturing method may be adopted only either at the step of forming the hole transporting layer 13a or at the step of forming the electron-transporting light emitting layer 13b. Particularly, only for the hole transporting layer 13a, the process of coating and drying the organic solution HMC and then coating the solvent HSL in the solution may be performed.

Then, as shown in FIG. 4D, an opposing electrode (for example, a cathode electrode) 14, which is made of a transparent electrode material such as ITO, etc. and formed so as to face each pixel electrode 12 via the organic EL layer comprising at least the above-described hole transporting layer 13a and electron-transporting light emitting layer 13b, is formed integrally in common for the respective pixel forming regions Apx. Then, a protective insulating film and a sealing resin layer 15 are formed on the panel substrate PSB including the opposing electrode 14 and a sealing substrate 16 is further joined, thereby completing the display panel 10, on which the display pixels PIX each comprising an organic EL element are arrayed two-dimensionally as shown in FIG. 1B.

As described above, according to the manufacturing method of the display device (display panel) according to the present embodiment, in the process of forming the organic EL layer (the hole transporting layer or the electron-transporting light emitting layer), the step of coating the organic solution containing the material for forming the hole transporting layer or the electron-transporting light emitting layer on the region for forming each display pixel (color pixel) and drying the organic solution to fix the hole transporting material or the electron-transporting light emitting material, and after this, the step of coating the solvent in the organic solution on the region for forming each display pixel to remelt (or redisperse) the hole transporting material or the electron-transporting light emitting material once fixed and then again drying the material to form the hole transporting layer or the electron-transporting light emitting layer, are performed.

The effects achieved by the manufacturing method of the display device (display panel) according to the present embodiment will now be verified in detail, by showing experimental data. Here, only the case of forming the hole transporting layer will be explained. However, needless to say, similar effects can be achieved in forming the electron-transporting light emitting layer.

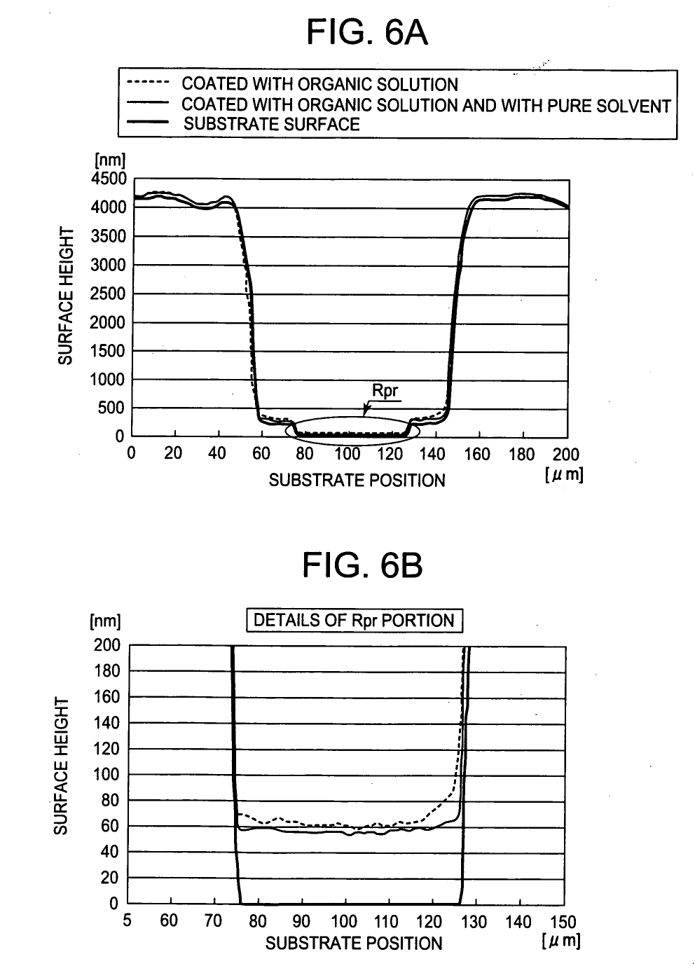

FIGS. 5A to 5D are conceptual diagrams showing the states of the film surface in the process of forming the organic EL layer (hole transporting layer), according to the present embodiment. FIGS. 6A and 6B show an example of experimental data for proving the effects obtained in the process of forming the organic EL layer (hole transporting layer) according to the present embodiment. FIGS. 6A and 6B are experimental data showing measurements of the state of the surface (the height of the surface) of the hole transporting layer, which is formed according to a manufacturing method (referred to as “prior method” for expediency) where an organic solution containing the above-described hole transporting material is coated on the surface of a panel substrate on which pixel electrodes which are at least superficially made of a transparent electrode material such as ITO or the like, and interlayer insulating films and partitioning walls made of an insulating material are formed, and then the organic solution is dried to fix the hole transporting material, or according to a manufacturing method (the method according to the present embodiment) where the organic solution is coated and dried, and the solvent (water) is further coated and dried to fix the hole transporting material. FIG. 6A is a diagram showing the state of the surface of the entire area of the pixel forming region defined by the interlayer insulating films and the partitioning walls (including the interlayer insulating films and the partitioning walls). FIG. 6B is a diagram showing a part of the state of the surface of the pixel forming region (on the pixel electrode) shown in FIG. 6A, in enlargement.

FIGS. 6A and 6B show the case that the hole transporting material is PEDOT/PSS described above, and the solvent is water. These experimental data are the data of the case where, on the condition that the direction in which the A-A line of FIG. 1A runs is defined as the widthwise direction (the shorter direction of each display pixel PIX), the configurations on the panel substrate PSB are that the exposed portion (aperture) of the pixel electrode 12 made of ITO formed in the pixel forming region Apx defined by the interlayer insulating films 11a and the partitioning walls 11b has a width WI of 55 μm and a length L1 of 375 μm, the interlayer insulating films 11a made of a silicon nitride film have a width W2 of 115 μm, a lengthwise interval L2 of 135 μm, and a height H2 of 200 nm, and the partitioning walls 11b made of polyimide have a width W3 of 75 μm and a height H3 of 4 μm.

As shown in FIG. 5A, when the organic solution HMC containing the hole transporting material (PEDOT/PSS) is jetted in a liquid current form from the ink nozzle onto the region (pixel forming region Apx) surrounded by the interlayer insulating films 11a and the partitioning walls 11b and coated on the pixel electrode 12, since the interlayer insulating films 11a and the partitioning walls 11b have a fine wettability to the organic solution HMC, a phenomenon occurs that the ends of the liquid surface of the organic solution HMC are pressed up along the side surfaces of the interlayer insulating films 11a and partitioning walls 11b, likewise as described above in the related art (see FIG. 8).

If the panel substrate PSB is heated in this state and the solvent in the organic solution HMC is vaporized to fix the hole transporting material on the pixel electrode 12, the hole transporting material aggregates near the boundary between the pixel electrode 12, and the interlayer insulating films 11a and partitioning walls 11b to make the film thickness near the boundary large while the hole transporting material is dissipated near the center portion of the pixel electrode 12 to make the film thickness at the center portion small. Therefore, the film thickness of the hole transporting material (referred to as “material film 13×” for expediency) fixed in the thin film form on the pixel electrode 12 is greatly uneven.

Hence, according to the present embodiment, as shown in FIG. 5C, the solvent (water) HSL constituting the organic solution HMC is jetted, in a liquid current form, from the ink nozzle in such a suitable amount as would not allow the solvent to overflow the pixel forming region Apx defined by the interlayer insulating films 11a and the partitioning walls 11b and coated on the material film 13× fixed on the surface of the pixel electrode 12, in order to remelt or redisperse at least the superficial portion of the material film (hole transporting material) 13× in the solvent HSL. The concentration of the hole transporting material when it is remelted or redispersed becomes lower than the concentration thereof in the organic solution HMC, thereby changing the wettability thereof from that when it is in the organic solution HMC.

Due to this, the hole transporting material spreads to make the liquid surface generally uniform over generally the entire area of the pixel forming region Apx (on the pixel electrode 12), and the pressing of the liquid surface ends due to the liquid repellency of the interlayer insulating films 11a and partitioning walls 11b and surface tension and cohesion of the organic solution, etc. is therefore eased. If the panel substrate PSB is heated in this state and the solvent in the organic solution is vaporized to re-fix the hole transporting material on the pixel electrode 12, the hole transporting layer 13a whose film thickness is generally uniform is formed on the pixel electrode 12 as shown in FIG. 5D.

According to this series of steps of forming the organic EL layer (hole transporting layer 13a), it was proved, as shown in FIGS. 6A and 6B, that the film thickness of the hole transporting layer 13a was more uniform according to the method of the present embodiment of remelting the hole transporting material in the solvent, than it was according to the prior method of coating the organic solution HMC and then drying the organic solution HMC to fix the hole transporting material and form the hole transporting layer 13a.

In FIGS. 6A and 6B, the bold solid line indicates the state of the surface (the height of the surface) of the substrate on which the organic solution containing the hole transporting material is coated, the thin solid line indicates the state of the surface of the hole transporting layer formed according to the method of the present embodiment (coating and drying the organic solution and again coating and drying the solvent), and the thin broken line indicates the state of the surface of the hole transporting layer formed according to the prior method (coating the organic solution and then drying the organic solution).

As shown in FIGS. 6A and 6B, according to the prior method (thin broken line), pressing up of the ends of the liquid surface of the organic solution HMC along the side surfaces of the interlayer insulating films 11a and partitioning walls 11b were observed, and the ratio of the region whose film thickness differed from the film thickness of the thinnest portion of the hole transporting layer 13a formed in the pixel forming region Apx by equal to or smaller than 5% of the film thickness of the thinnest portion is 72%. According to the method of the present embodiment (thin solid line) in which the solvent is re-coated, it was proved that this ratio was improved to 85% and the film was formed to have a small film thickness over the entire area of the pixel forming region Apx.

Hence, according to the present embodiment, it is possible to form an organic EL layer (hole transporting layer 13a), whose film thickness is small and generally uniform, in the pixel forming region Apx (on the pixel electrode 12) defined by the interlayer insulating films 11a and the partitioning walls 11b. As a result, the light emission start voltage in the light emitting operation and the wavelength (chromaticity) of the light hv emitted from the organic EL layer do not differ from the design values to make it possible to obtain a desired display quality, and a decrease in the aperture ratio of the display panel and the deterioration of the organic EL element are prevented to make is possible to realize a display panel excellent in reliability and longevity.

Regarding the steps of forming the organic EL layer shown in the above-described embodiment, a case has been explained that the organic solution containing the hole transporting material or the electron-transporting light emitting material is coated on the pixel forming region and dried, and then the solvent constituting the organic solution is re-coated. The present invention is not limited to this case. For example, an organic solution whose concentration is low as equal to or smaller than 1/10 of the concentration of the organic solution first coated, a liquid that can dissolve the organic solution, etc., i.e., any liquid that has an effect of remelting or redispersing the hole transporting material or the electron-transporting light emitting material fixed on the pixel forming region Apx (pixel electrode 12) may be re-coated.

In the above-described embodiment, a case has been explained that the nozzle printing method is used as a method for coating the organic solution containing the hole transporting material or the electron-transporting light emitting material on the pixel forming region Apx on the panel substrate PSB. The present invention is not limited to this case, but needless to say, an ink jetting method or other coating methods (printing techniques) may be used.

In the above-described embodiment, the organic EL layer 13 comprises the hole transporting layer 13a and the electron-transporting light emitting layer 13b. The present invention is not limited to this case, but the organic EL layer 13 may comprise only a dual-functional hole-transporting/electron-transporting light emitting layer. Alternatively, the organic EL layer 13 may comprise a hole-transporting light emitting layer and an electron transporting layer, or arbitrarily comprise a carrier transporting layer in-between, or may have a carrier transporting layer of other kinds combined.

In the above-described embodiment, the pixel electrode 12 is an anode. However, this is not the only case but the pixel electrode 12 may be a cathode. In this case, it is only necessary that any carrier transporting layer of the organic EL layer 13 that contacts the pixel electrode 12 should be an electron transporting layer.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2005-374987 filed on Dec. 27, 2005 and including specification, claims, drawings and summary. The disclosure of the above Japanese Patent Application is incorporated herein by reference in its entirety.

What is claimed is:

1. A manufacturing method of a display device which has a display pixel having a light emitting element including a carrier transporting layer, the method comprising:
a material fixing step of coating a solution containing a carrier transporting material on a pixel forming region for forming the display pixel, and drying the solution to fix the carrier transporting material in a thin film form; and
a carrier transporting layer forming step of coating a liquid material for remelting or redispersing the fixed carrier transporting material on the pixel forming region, and forming the carrier transporting layer, which is made of the carrier transporting material.

2. The manufacturing method of the display device according to claim 1,
wherein the liquid material for remelting or redispersing the carrier transporting material used at the carrier transporting layer forming step contains a same material as a solvent in the solution containing the carrier transporting material used at the material fixing step.

3. The manufacturing method of the display device according to claim 1,
wherein the pixel forming region is defined by partitioning walls.

4. The manufacturing method of the display device according to claim 3,
wherein a plurality of pixel forming regions for forming display pixels having light emitting elements for a same light emitting color as each other are formed in a region surrounded by the partitioning walls.

5. The manufacturing method of the display device according to claim 1,
wherein in a process of coating the solution containing the carrier transporting material at the material fixing step and in a process of coating the liquid material for remelting or redispersing the carrier transporting material at the carrier transporting layer forming step, the solution or the liquid material is continually coated onto a plurality of pixel forming regions, according to a nozzle printing method.

6. The manufacturing method of the display device according to claim 1,
wherein the carrier transporting material comprises a polymer material, and the light emitting element is an organic electroluminescence element.

7. The manufacturing method of the display device according to claim 1,
wherein the carrier transporting material contains polyethylenedioxithiophene.

8. The manufacturing method of the display device according to claim 1,
wherein the carrier transporting material contains a conjugated double bond polymer.

9. The manufacturing method of the display device according to claim 1,
wherein the solution containing the carrier transporting material contains at least any of water, ethanol, and ethylene glycol.

10. The manufacturing method of the display device according to claim 1,
wherein the liquid material for melting or redispersing contains at least any of water, ethanol, and ethylene glycol.

11. A manufacturing method of a display device which has a display pixel having a light emitting element including a carrier transporting layer, the method comprising:
a material fixing step of coating a solution containing a carrier transporting material on a pixel forming region for forming the display pixel defined by a partitioning wall, and drying the solution to fix the carrier transporting material in a thin film form; and
a carrier transporting layer forming step of coating a same material as a solvent contained in the solution containing the carrier transporting material, as a liquid material for remelting or redispersing the fixed carrier transporting material, and forming the carrier transporting layer, which is made of the carrier transporting material.

12. A manufacturing equipment of a display device, the equipment coating a carrier transporting material, which has been fixed in a thin film form by a solution containing the carrier transporting material being coated on a pixel forming region for forming a display pixel, with a liquid material for remelting or redispersing the carrier transporting material.
